(19) United States
(12) Patent Application Publication
(10) Pub. No.: US 2020/0066108 A1
(43) Pub. Date: Feb. 27, 2020

(54) CARD GAMING MACHINE

(71) Applicant: David Simonek, Costa Mesa, CA (US)

(72) Inventor: David SIMONEK, Costa Mesa, CA (US)

(21) Appl. No.: 16/666,234

(22) Filed: Oct. 28, 2019

Related U.S. Application Data
(63) Continuation-in-part of application No. 16/454,590, filed on Jun. 27, 2019.
Application No. 16/454,590 is a continuation-in-part of application No. 15/352,564, filed on Nov. 15, 2016, now abandoned.

(51) Int. Cl. G07F 17/32; A63F 1/00; A63F 3/00

(52) U.S. Cl. CPC G07F 17/3293; G07F 17/3267; A63F 2001/005; A63F 3/00157; G07F 17/3211; A63F 1/00

(57) ABSTRACT

A card game device is provided in which winning mathematic combinations are used from a single deck of cards using symbols that determine calculations using certain aspects of the game. In this card game no cards are provided to the player. In this card game there could be one or more players. Cards are placed in a game board made out of cloth in which there are nine rectangular shapes displayed in a rectangular array within the center of an octagon shape display. Each bet can be played and/or evaluated using certain aspects of the game. At least some prizes or top winning outcomes for a round of play must include wining outcomes from at least one, and preferably from all bets played by a given player.

This application is a continuation in part of and claims priority to parent application Ser. No. 16/454,590 filed Jun. 27, 2019 by inventor David Simonek, which in turn claims priority to parent application by inventor David Simonek Ser. No. 15/352,564, of Nov. 15, 2016.

### DISCUSSION OF RELATED ART

A variety of patents describe gaming machines and wagering machines. For example, in the U.S. Pat. No. 9,959,703, Gaming Machine With Symbol Replacement by inventor Terence Igesund, published May 1, 2018 the abstract discloses, “A gaming machine may determine that a trigger event for a bonus game occurred during a base outcome event of a base game, wherein the base game and the bonus game are both reel-based games being executed on behalf of a client machine. In response, the gaming machine may award use of two or more replaceable symbols for the bonus game. Until all of the replaceable symbols have been used, the gaming machine may repeatedly carry out iterations of bonus game operations including: determining a symbol set for display on a plurality of reels, where the symbol set includes non-replaceable symbols and zero or more replaceable symbols, and where each displayed replaceable symbol is successively replaced in the display by either a new non-replaceable symbol or a new replaceable symbol until no displayed replaceable symbols remain on the plurality of reels.” Igesund has international classes (A63F 13/00 (2014.01); G07F 17/32 (2006.01); G07F 17/34 (2006.01) and US classes (G07 17/3213 (2013.01); G07F 17/326 (2013.01); G07F 17/3267 (2013 01); G07F 17/34 (2013.01).

For example, in the U.S. Pat. No. 9,652,939, System And Method Of Conducting Games Of Chance As a Proxy Or Basis For Another Player by inventor Sean Malek, published May 16, 2017 the abstract discloses, “To bring the excitement to the people (majority, who are not experts in games), we present the examples, described here, for one person to be able to bet on and be part of the deal and excitement for a third party, as his agent, proxy, or shadow, to bet for him, or instead of him, or as if the first person was doing the game directly, or one betting for another, or one playing for another with the other person's money. That generates more excitement on the game or casino, with more participation, transactions, income, profit, loyalty, and repeat customers. This brings a lot of variations on the game, e.g., stock market model, or derivatives model, or hedge model. This can be applied to sports and table games or fantasy sports. This can be applied to online, real, mobile, fantasy, simulation, computer generated, human based, or casino games or settings.”

For example, in the U.S. Pat. No. 9,754,452, Bonus Event In Slot Machine Play by inventor Sarah Anne St. John, published Sep. 5, 2017 the abstract discloses, “A method and apparatus provides a bonus event on an electronic video gaming machine having touchscreen sensitivity on a video display in communication with a processor. The method includes: a) triggering a bonus event; b) providing and displaying at least one wild card symbol in a fixed position in columns and rows used to determine a bonus outcome; c) the processor generates a first random symbol for use in the bonus game which is displayed on the video gaming machine; d) the touch screen is activated so that a final position for the first random symbol is selectable by touchscreen activity; e) the processor filling the unfilled frames with random symbols; and f) the processor resolving a bonus outcome of the bonus outcome according to paylines within the columns and rows used to determine the bonus outcome.”

For example, in the U.S. Pat. No. 9,773,374, Slot Machine by inventor Allen Stone, published Sep. 26, 2017 the abstract discloses, “A slot machine device providing a unique operation, payout scheme, and structure. This slot machine provides optional, unique game play features. These features may include a Notice feature which informs a player if the next cycle will be a win or a loss; a Flush feature allowing a player to discard a losing cycle; and a Do-Over feature, allowing a player to replay a cycle if they do not like the results of the prior cycle. These features may be turned on and off, and the slot machine may be configured to automatically adjust a payout option depending on what features are activated.”

For example, in the U.S. Pat. No. 9,805,541, Electronic Gaming Device With Second Chance Functionality by inventor Jason Prometheus, published Oct. 31, 2017 the abstract discloses, “Examples disclosed herein relate to a gaming device including a memory, a processor, a plurality of reels, and a display. The display includes active areas and inactive areas where the active areas are utilized for payout determinations and bonus game initiation determinations and where the inactive areas are not utilized for payout determinations and bonus game initiation determinations. The processor may initiate a base game play, a bonus game, and a secondary base game. The base game play may include a spin to display at least a portion of the plurality of reels in the active areas. The processor may initiate a bonus game based on a predetermined number of a predetermined symbol being located in the active areas after the spin. The processor may initiate a secondary base game based on a number of the predetermined symbol being less that the predetermined number and a secondary base game triggering event. The secondary base game may convert a first inactive area to a first secondary base game play active area where the first secondary base game play active area is utilized for payout determinations and bonus game initiation determinations.”

For example, in the U.S. Pat. No. 9,842,473, Gaming Machine by inventor Masumi Fujisawa, published Dec. 12, 2017 the abstract discloses, “After determining that a game state is a non-play state, it is determined whether or not a credit required for a play has been inputted within a predetermined time period. When the credit has not been inputted within the predetermined time period, a display mode in which a plurality of different bonus ranks are displayed on a middle image display panel in a first state in which a bonus or bonuses are likely to be obtained by a drawing and in a second state in which the bonus or bonuses are not obtained thereby is switched to a display mode in which all of the plurality of bonus ranks displayed in display areas are displayed in either of the first state or the second state.”

For example, in the U.S. Pat. No. 9,997,010, Electronic Gaming Device With External Lighting Functionality by inventor Sigmund Lee, published Jun. 12, 2018 the abstract discloses, “Examples disclosed herein relate to a gaming device including a memory, a processor, a display, a plurality of display areas located on the display, and a plurality of external lights located at an outer area of a front surface of the electronic gaming device. The plurality of external lights forming a u-shape with a left side, a right side, and a bottom where each of the left side, the right side, and the bottom includes a first light column, a second light column, and a third light column. The gaming device including a processor that initiates a base game via the plurality of display areas located on the display.”

For example, in the U.S. Pat. No. 10,068,432, Gaming Machine With Symbol Propagation by inventor Jonathan B. Wortmann, published Sep. 4, 2018 the abstract discloses, “An embodiment may involve selecting a set of symbols associated with an outcome event of a reel-based game. The reel-based game may be executed on behalf of a client machine, and selecting the set of symbols may involve spinning a plurality of reels to determine the outcome event. The embodiment may further involve determining that the set of symbols includes a predetermined symbol on a designated reel and does not include any winning combination. The embodiment may also involve, possibly in response to determining that the set of symbols includes the predetermined symbol on the designated reel and does not include any winning combination, replacing one or more symbols in the set of symbols with predetermined symbols such that the symbol set after replacement includes a winning combination.”

For example, in the U.S. Pat. No. 10,007,894, Method And System For Facilitating Monetary Value Gaming Ticket Redemption by inventor Sean Malek, published Sep. 18, 2018 the abstract discloses, “In accordance with a method and system for facilitating redemption of monetary value gaming tickets, such as issued by a gaming device upon cash-out, a ticket is presented to a redemption kiosk. If the ticket is validated or approved for payment and has a monetary value which includes a fractional currency value, then the player is offered the opportunity to place a wager which includes the fractional currency value in order to play a wagering game. If the player elects to play the game, the game is presented. If the outcome of the game is losing, then the player is paid a first whole currency value comprising the monetary value less the wager via currency dispensed from the kiosk and when an outcome of the wagering game is winning, then the player is paid a second whole currency value which is greater than the monetary value (such as by including a winning amount) via currency dispensed from said currency dispensing device.”

For example, in the U.S. Pat. No. 10,176,671, Gaming System And Method Having A Secondary Symbol Award Enhancement by inventor Michael Charles Halvorson, published Jan. 8, 2019 the abstract discloses, “Various embodiments of a gaming system and method are disclosed as having secondary symbol sets that are used to enhance initial payout awards associated with winning symbol combinations. The gaming system may generate and display one or more symbols from the secondary symbol set in symbol display positions associated with symbols that formed a winning symbol combination. The generated symbols from the secondary symbol set and the symbols that formed winning symbol combinations can be displayed in the same symbol display positions at substantially the same time. In some embodiments, the symbols in the secondary symbol set comprise a plurality of different color symbols, where the color symbols are each associated with awards that may enhance a payout award associated with the winning symbol combination. Thus, generating the secondary symbols in association with the symbol display positions of the winning symbol combination may enhance or improve an initial payout award.”

For example, in the U.S. Pat. No. 10,269,217, Gaming Machine, Control Method For Machine, And Program For Gaming Machine With Symbol Animation Across Triggered Games by inventor Daisuke Nakamura, published Apr. 23, 2019 the abstract discloses, “A gaming machine that provides an operation unit, a display unit and a control unit. The operation unit is configured to receive an operation of the player. The display unit is operably coupled to the operation unit and is configured to displa20ly a first feature symbol display area, a second feature symbol display area and a third feature display area. Each display area includes a plurality of cells arranged in a grid. The control unit is operably coupled to the operation unit and the display unit and is configured to provide a primary game and a feature game. The three display areas are used in the feature game in turn. Any appearance of a predetermined symbol in one of the display areas is copied in to the next display area(s) in sequence.”

For example, in the U.S. Pat. No. 10,275,991, Multi-Slot Game Within Slot Game by inventor Nathan Lee Craig, published Apr. 30, 2019 the abstract discloses, “Various embodiments of the present invention generally relate to operating a gaming machine to generate a wager-based video slot game. In a particular embodiment, a plurality of video slot reel games can be generated simultaneously and independently of one another. For example, nine video slot reel games can be generated simultaneously. In each of the video slot reel games, the symbols falling on one or more pay lines can be evaluated for winning combinations. In addition, a secondary array, such as a three by three array, can be populated with symbols that were presented in the plurality of video slot reel games. The symbols appearing in the secondary array can be presented to display like an additional video slot game. The symbols falling on one or more pay lines through the secondary array can be evaluated for winning combinations.”

### SUMMARY OF THE INVENTION

A method of conducting a game of chance includes the steps of providing a processor for an electronic gaming device. A processor is configured to graphically output a game table on a display. The processor defines at least a square array of three rows by three columns. The processor defines a deck of cards, and assigning each card in the deck of cards a card symbol. Some of the cards symbols are duplicates or triplicates of each other. The number of cards is a preset finite amount. The method also includes the step of defining betting lines along the rows, columns and diagonals of the square array, and receiving bet inputs from players on the betting lines. The configuring of the processor is to select a set of cards from the deck of cards and assigning the selected set of cards to the spaces in the square array. The configuring of the processor also includes the cause of a graphical display to show the card symbols related to each card in the selected set of cards. When determining a payout, the price board payout chart is used by comparing all of the selected cards on all of the betting lines and then multiplying the bet by the payout. The card symbols are populated on the square array one at a time with a delay between cards and also the card symbols are populated one row at a time. The price board payout chart is configured to provide a winning bet with at least 2-3 selected card symbols that are on the same horizontal, vertical, and/or diagonal betting line. An orientation from all directions, including left to right, right to left, up to down, down to up, diagonally upper left to bottom right and vice versa, and diagonally lower left to upper right and vice versa. The sixteen betting lines are defined around the 3×3 array. Each of the betting line has a betting area for receiving a user input, which is indexed from one through sixteen. The processor is configured to receive bets from players on multiple lines from line one through line sixteen. The player may bet on all sixteen lines at once by using a bet all betting area located on the game board. Each step of configuration the processor to provide a bet jackpot area. The jackpot card in the deck of cards is defining a space in the square array as a jackpot space assigned a spot for the jackpot card. The payout table includes a condition of having a jackpot card in the jackpot space, wherein the jackpot is won when the jackpot card appears in the jackpot space. The jackpot space is defined in the center of the game board, which is space five on a square array of three rows by three columns. The jackpot space is marked as a jackpot space.

The processor is configured to allow a jackpot bet on the bet jackpot area only when a player puts a bet in the ‘bet all’ area and places a fixed wager on the “Jackpot” symbol located on the game board. The game board has two bet jackpot bet areas. Mainly a first bet jackpot area is located on a right side of the game board and a second located on a left side of the game board. The initial value of the jackpot is seeded at a set amount. The jackpot is progressive and increases with all losing bets.

A given player during any one round of the game played, effectively has two or more matching cards within each line that the player places a bet. Preferably there is at least one card which is common to two or more of each bet. In one embodiment, each player places a bet on one or more or all of the sixteen lines provided on the game board. The dealer than pulls out nine (9) cards from the deck of cards and arranges the cards face up on the center of the octagon shape in which there are nine (9) rectangular shapes and sixteen (16) betting lines displayed around the octagon which are displayed in the center of the game board which is made out of cloth. The dealer displays the cards in the above-mentioned area in a fashionable order by placing the first card on the first column starting from the top to bottom and continuing to the second column from top to bottom and continuing to the third column from top to bottom. In order to have a winning bet the player must match at least two to three identical cards running consecutively, horizontally, vertically, or diagonally from all directions, including left to right, right to left, up and down, down and up, diagonally upper left to bottom right and vice versa, diagonally lower left to upper right and vice versa. The sixteen (16) betting areas described above are indexed from one (1) through sixteen (16). Players can bet on multiple lines from lines 1 (one) through sixteen (16) and if desired the player may bet on all sixteen (16) lines at once by using any of the four (4) “Bet All” betting areas located on the game board. Two of the “Bet All” symbols are located on the right side of the game board next to the octagon shape and the other two “Bet All” symbols are located on the left side of the game board next to the octagon shape that is displayed in the game board. Players may bet different values/amounts as desired.

This device also called Table Slot King contains a game version which provides a jackpot betting option. This version contains one jackpot card in the deck of cards. The game board contains an assigned spot for the “Jackpot” card. This designated spot for the “Jackpot” card is displayed in the center of the game board located in within the center of the octagon and is specifically marked “Jackpot” with a royal crown symbol at the top of the “Jackpot” symbol and three asterisk stars symbols located directly beneath the “Jackpot” symbol. To be evaluated as the winner of the “Jackpot” hand, the player must “Bet All” and place a fixed wager of $1.00 on the “Jackpot” symbol located in the game board. The game board contains two “Bet Jackpot” symbols. One “Bet Jackpot” symbol is located on the right side and the left side of the game board between the “Bet All” symbols located directly above and beneath the “Bet Jackpot” symbol. The “Jackpot” symbol contains a royal crown symbol directly above and three asterisk stars symbols located directly beneath the “Bet Jackpot” symbol. The House will provide a seed amount for the “Jackpot” hand valued at $80.00. In the event that a player is evaluated and wins the “Jackpot” hand valued at $80.00, the house will seed the “Jackpot” for another $80.00 and so on. Each bet can be played and/or evaluated using certain aspects of blackjack, poker or other traditional card game play or evaluation.

Table Slot King can provide various variations/version of card decks. There are currently four variations; a first variation contains 41 cards; a second variation contains 48 cards; a third variation contains 50 cards; and a fourth variation contains 51 cards.

An object of the invention includes providing casino players or other game players the opportunity to win relatively large prizes in addition to numerous smaller prizes. Large prize games are believed to attract casino customers even when the large prizes have relatively small odds (relatively low probability of being won, in any round of the game) and, indeed it generally is found that casinos must provide relatively low odds for large-sized prizes, as a practical matter. Table Slot King provides for at least some winnings or outcomes with relatively low odds of occurrence and which, accordingly can be feasibly associated with relatively large prizes. Although there are numerous manners of potential low-odds winning outcomes, Table Slot King provides a relatively larger number of cards as to maintain a high level of entertainment value or other interest-generating aspects of the game and/or maintain certain of the features of the games with which players may be familiar and/or comfortable.

### BRIEF DESCRIPTION OF THE DRAWINGS

FIG. 1 is an exemplar prior art machine implementation architecture.

FIG. 2 is an exemplar prior art client server implementation architecture.

FIG. 3 is a price board payout chart depicting the values of the symbols for each card according to an embodiment of the present invention.

FIG. 4 is a price board payout chart depicting the values of the symbols for each card according to an embodiment of the present invention.

FIG. 5 is a price board payout chart depicting the values of the symbols for each card according to an embodiment of the present invention.

FIG. 6 is a price board payout chart depicting the values of the symbols for each card according to an embodiment of the present invention.

FIG. 7 is a diagram of a display of the game board.

FIG. 8 displays an arrangement of cards during game play according to an embodiment of the present invention.

FIG. 9 displays an arrangement of cards before replacement of seven cards.

FIG. 10 displays a new set of cards that were replaced and showing a winning three in a row game play.

FIG. 11 displays an arrangement of cards before replacement of thirteen cards.

FIG. 12 displays a new set of cards after some were replaced and showing a jackpot winning four in a row game play.

The following call out list of elements is useful for referencing the element numbers of the drawings.
1 first array variable
2 second array variable
3 third array variable
4 fourth array variable
5 fifth array variable
6 sixth array variable
7 seventh array variable
8 eighth array variable
9 ninth array variable
11 first row
12 second row
13 third row
14 column one
15 column two
16 column three
21 space one
22 space two
23 space three
24 space four
25 space five
26 space six
27 space seven
28 space eight
29 space nine
A1 line one
A2 line two
A3 line three
A4 line four
A5 line five
A6 line six
A7 line seven
A8 line eight
A9 line nine
A10 line ten
A11 line eleven
A12 line twelve
A13 line thirteen
A14 line fourteen
A15 line fifteen
A16 line sixteen
B1 first bet all field
B2 second bet all field
B3 third bet all field
B4 fourth bet all field
C1 first bet jackpot field
C2 second bet jackpot field
D1 player 1
D2 player 2
D3 player 3
D4 player 4
301 winning prize of 3× three seven card symbol in variation one
302 winning prize of 2× three seven card symbol in variation one
303 winning prize of 3× seven card symbol in variation one
304 winning prize of 2× seven card symbol in variation one
305 winning prize of 3× crown card symbol in variation one
306 winning prize of 2× crown card symbol in variation one
307 winning prize of 3× two bar card symbol in variation one
308 winning prize of 2× two bar card symbol in variation one
309 winning prize of 3× dollar sign card symbol in variation one
310 winning prize of 2× dollar sign card symbol in variation one
311 winning prize of 3× four cherry card symbol in variation one
312 winning prize of 2× four cherry card symbol in variation one
313 winning prize of 3× melon card symbol in variation one
314 winning prize of 2× melon card symbol in variation one
315 winning prize of 3× bar card symbol in variation one
316 winning prize of 2× bar card symbol in variation one
331 three seven card symbol in variation one
332 seven card symbol in variation one
333 crown card symbol in variation one
334 two bar card symbol in variation one
335 dollar sign card symbol in variation one
336 two cherry card symbol in variation one
337 melon card symbol in variation one
338 bar card symbol in variation one
351 number of three seven card symbols in deck in variation one
352 number of seven card symbols in deck in variation one
353 number of crown card symbols in deck in variation one
354 number of two bar card symbols in deck in variation one
355 number of dollar sign card symbols in deck in variation one
356 number of two cherry card symbols in deck in variation one
357 number of melon card symbols in deck in variation one
358 number of bar card symbols in deck in variation one
401 winning prize of 3× three seven card symbol in variation two
402 winning prize of 2× three seven card symbol in variation two
403 winning prize of 3× seven card symbol in variation two
404 winning prize of 2× seven card symbol in variation two
405 winning prize of 3× crown card symbol in variation two
406 winning prize of 2× crown card symbol in variation two
407 winning prize of 3× two bar card symbol in variation two
408 winning prize of 2× two bar card symbol in variation two
409 winning prize of 3× dollar sign card symbol in variation two
410 winning prize of 3× dollar sign card symbol in variation two
411 winning prize of 3× four cherry card symbol in variation two
412 winning prize of 2× four cherry card symbol in variation two
413 winning prize of 3× bar card symbol in variation two
414 winning prize of 2× bar card symbol in variation two
415 winning prize of 3× melon card symbol in variation two
416 winning prize of 2× melon card symbol in variation two
417 winning prize of 3× two cherry card symbol in variation two
418 matching all symbols in variation two
431 three seven card symbol in variation two
432 seven card symbol in variation two
433 crown card symbol in variation two
434 two bar card symbol in variation two
435 dollar sign card symbol in variation two
436 four cherry card symbol in variation two
437 bar card symbol in variation two
438 melon card symbol in variation two
439 two cherry card symbol in variation two
440 wild card symbol in variation two
451 number of three seven card symbols in deck in variation two
452 number of seven card symbols in deck in variation two
453 number of crown card symbols in deck in variation two
454 number of two bar card symbols in deck in variation two
455 number of dollar sign card symbols in deck in variation two
456 number of four cherry card symbols in deck in variation two
457 number of bar card symbols in deck in variation two
458 number of melon card symbols in deck in variation two
459 number of two cherry card symbols in deck in variation two
460 number of wild card symbols in deck in variation two
501 winning prize of 3× three seven card symbol in variation three
502 winning prize of 2× three seven card symbol in variation three
503 winning prize of 3× seven card symbol in variation three
504 winning prize of 2× seven card symbol in variation three
505 winning prize of 3× crown card symbol in variation three
506 winning prize of 2× crown card symbol in variation three
507 winning prize of 3× two bar card symbol in variation three
508 winning prize of 2× two bar card symbol in variation three
509 winning prize of 3× dollar sign card symbol in variation three
510 winning prize of 3× dollar sign card symbol in variation three
511 winning prize of 3× four cherry card symbol in variation three
512 winning prize of 2× four cherry card symbol in variation three
513 winning prize of 3× bar card symbol in variation three
514 winning prize of 2× bar card symbol in variation three
515 winning prize of 3× melon card symbol in variation three
516 winning prize of 2× melon card symbol in variation three
517 winning prize of 3× two cherry card symbol in variation three
518 matching all symbols category in variation three
531 three seven card symbol in variation three
532 seven card symbol in variation three
533 crown card symbol in variation three
534 two bar card symbol in variation three
535 dollar sign card symbol in variation three
536 four cherry card symbol in variation three
537 bar card symbol in variation three
538 melon card symbol in variation three
539 two cherry card symbol in variation three
540 wild card symbol in variation three
551 number of three seven card symbols in deck in variation three
552 number of seven card symbols in deck in variation three
553 number of crown card symbols in deck in variation three
554 number of two bar card symbols in deck in variation three
555 number of dollar sign card symbols in deck in variation three
556 number of four cherry card symbols in deck in variation three
557 number of bar card symbols in deck in variation three
558 number of melon card symbols in deck in variation three
559 number of two cherry card symbols in deck in variation three
560 number of wild card symbols in deck in variation three
601 winning prize of 3× three seven card symbol in variation four
602 winning prize of 2× three seven card symbol in variation four
603 winning prize of 3× seven card symbol in variation four
604 winning prize of 2× seven card symbol in variation four
605 winning prize of 3× crown card symbol in variation four
606 winning prize of 2× crown card symbol in variation four
607 winning prize of 3× two bar card symbol in variation four
608 winning prize of 2× two bar card symbol in variation four
609 winning prize of 3× dollar sign card symbol in variation four
610 winning prize of 3× dollar sign card symbol in variation four
611 winning prize of 3× four cherry card symbol in variation four
612 winning prize of 2× four cherry card symbol in variation four
613 winning prize of 3× bar card symbol in variation four
614 winning prize of 2× bar card symbol in variation four
615 winning prize of 3× melon card symbol in variation four
616 winning prize of 2× melon card symbol in variation four
617 winning prize of 3× two cherry card symbol in variation four
618 matching all symbols category in variation four
631 three seven card symbol in variation four
632 seven card symbol in variation four
633 crown card symbol in variation four
634 two bar card symbol in variation four
635 dollar sign card symbol in variation four
636 four cherry card symbol in variation four
637 bar card symbol in variation four
638 melon card symbol in variation four
639 two cherry card symbol in variation four
640 wild card symbol in variation four
641 jackpot card symbol in variation four
651 number of three seven card symbols in deck in variation four
652 number of seven card symbols in deck in variation four
653 number of crown card symbols in deck in variation four
654 number of two bar card symbols in deck in variation four
655 number of dollar sign card symbols in deck in variation four
656 number of four cherry card symbols in deck in variation four
657 number of bar card symbols in deck in variation four
658 number of melon card symbols in deck in variation four
659 number of two cherry card symbols in deck in variation four
660 number of wild card symbols in deck in variation four
800 hold card
801 first hold card
802 second hold card
811 first replacement card
812 second replacement card
813 third replacement card
814 fourth replacement card
815 fifth replacement card
816 sixth replacement card
817 seventeenth replacement card
818 winning cards
820 new cards
821 first new card
822 second new card
823 third new card
824 fourth new card
825 fifth new card
826 sixth new card
827 seventh new card
888 graphical display screen
900 hold cards
901 first hold card
902 second hold card
903 third hold card
911 first replaced card
912 second replaced card
913 third replaced card
914 fourth replaced card
915 fifth replaced card
916 sixth replaced card
917 seventh replaced card
918 eight replaced card
919 ninth replaced card
920 tenth replaced card
921 eleventh replaced card
922 twelfth replaced card
923 thirteenth replaced card
924 four in a row winning cards

### DETAILED DESCRIPTION OF THE PREFERRED EMBODIMENTS

An exemplar machine is described in the prior art as U.S. Pat. No. 9,959,703 issued May 1, 2018 to inventor Terence Igesund, the disclosure of which is incorporated herein by reference, and can be implemented here as well.

### Igesund States:

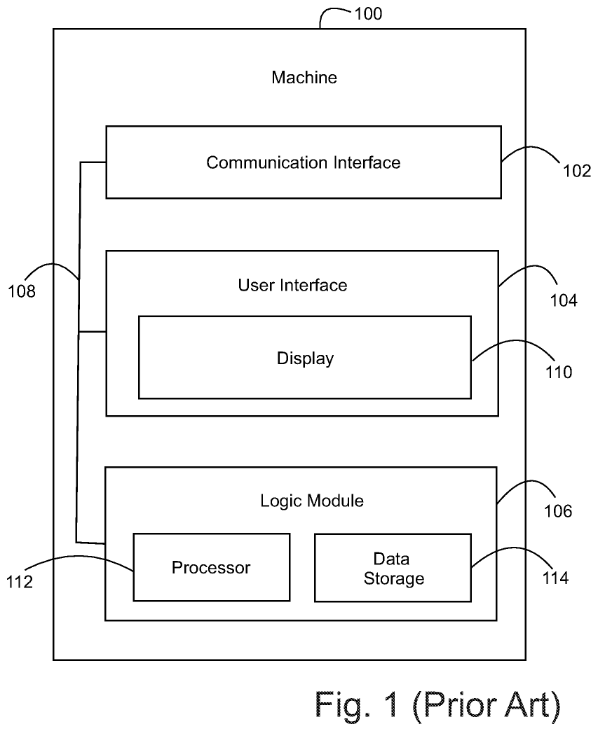

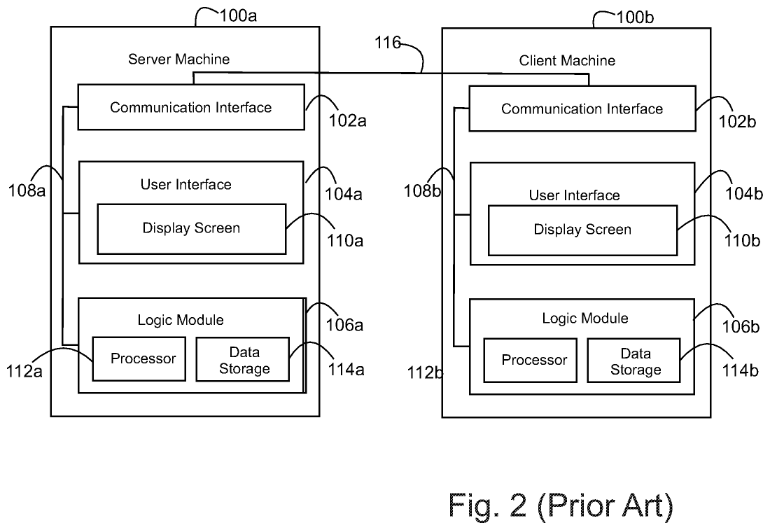

FIG. 1 shows a simplified block diagram of an example machine 100 arranged to implement operations in accordance with example methods described herein. Machine 100 may take any of a variety of forms, including for example a dedicated gaming machine, a personal computer, a server computer, a personal digital assistant, a mobile phone, a tablet device, or some other computing device.
Machine 100 may include a communication interface 102, a user interface 104, and a logic module 106, all of which may be coupled together by a system bus, network, or other connection mechanism 108. The communication interface 102 may include a wired or wireless network communication interface. For purposes of this description, any data described as being sent or transmitted by machine 100 can be data sent by communication interface 102 over a communication network. Also, for purposes of this description, any data described as being received by machine 100 can be data sent to communication interface 102 over a communication network.
The user interface 104 may facilitate interaction with a user (e.g., a player of a game) if applicable. As such, the user interface 104 may take the form of a GUI and may include output components such as a speaker and a display 110, and input components such as a keypad or a touch-sensitive screen. As described in greater detail below, display 110 may be configured to display, among other things, a symbol set in a game or a portion thereof.
The logic module 106 can take the form of a processor 112 and a data storage 114. The processor 112 can include a general-purpose processor (e.g., a microprocessor) or a special-purpose processor (e.g., a digital signal processor or an application specific integrated circuit) and may be integrated in whole or in part with the communication interface 102 or the user interface 104. Any processor discussed in this description or shown in the drawings can be referred to as a computer-readable processor. Any data storage discussed in this description or shown in the drawings can be referred to as computer-readable data storage.
Data storage 114 may include volatile or non-volatile storage components and may be integrated in whole or in part with processor 112. Data storage 114 may take the form of a non-transitory computer-readable medium and may include software program instructions, that when executed by processor 112, cause machine 100 to perform one or more of the operations described herein. Any software program instructions discussed in this description or shown in the drawings can be referred to as computer-readable program instructions, or more simply, program instructions.
Data storage 114 may also include operating system software on which machine 100 may operate. For example, machine 100 may operate on a Windows®-based operating system (e.g., Windows XP or Windows 7) provided by the Microsoft® Corporation of Redmond, Wash. Other examples of operating systems are possible.
FIG. 2 is a simplified block diagram of an example server machine 100 a connected to an example client machine (sometimes referred to as a workstation) 100 b over a computer-network 116. A configuration of elements including server machine 100 a and client machine 100 b can be referred to as a server-client based configuration.
The components of the server machine 100 a and the client machine 100 b are shown with corresponding “a” and “b” reference numerals (i.e., based on machine 100). Server machine 100 a includes communication interface 102 a, user interface 104 a (which incorporates display screen 110 a), logic module 106 a (which incorporates processor 112 a and data storage 114 a), and communication bus 108 a. Likewise, client machine 100 b includes communication interface 102 b, user interface 104 b (which incorporates display screen 110 b), logic module 106 b (which incorporates processor 112 b and data storage 114 b), and communication bus 108 b.
The server machine 100 a is configured to communicate with the client machine 100 b over the computer-network 116 (via the communication interfaces 102 a, 102 b). Likewise, the client machine 100 b is configured to communicate with the server machine 100 a over the computer-network 116. For purposes of this description, any data described as being sent or transmitted by the server machine 100 a can be data sent by communication interface 102 a over communication network 116. Similarly, any data described as being sent or transmitted by the client machine 100 b can be data sent by communication interface 102 b over communication network 116. Furthermore, for purposes of this description, any data described as being received by the server machine 100 a can be data the server machine 100 a receives from the communication network 116 using communication interface 102 a. Similarly, any data described as being received by the client machine 100 b can be data the client machine 100 b receives from the communication network 116 using communication interface 102 b.
The computer-network 116 for the server-client based configuration described above may take a variety of forms. For example, the computer-network 116 may be a local area network (LAN) in a casino, such that client machines 100 b dispersed throughout the casino may communicate with the server machine 100 a in the casino.
In another example, the computer-network 116 may be a wide-area network (WAN), such as an Internet network or a network of the World Wide Web. In such a configuration, the client machine 100 b may communicate with the server machine 100 a via a website portal (for a virtual casino) hosted on the server machine 100 a. The data described herein as being transmitted by server machine 100 a to client machine 100 b or by client machine 100 b to server machine 100 a can be transmitted as datagrams according to the user datagram protocol (UDP), the transmission control protocol (TCP), or another protocol.
The computer-network 116 may include any of a variety of network topologies and network devices, and may employ traditional network-related technologies, including for example the public switched telephone network, cable networks, cellular wireless networks, WiFi, and WiMAX. Further, the computer-network 116 may include one or more databases (e.g., a player credit account database), to allow for the storing and retrieving of data related to performing an outcome event by a machine, as well as adjusting account balances associated with client machines.
For purposes of this description, any operation listed in a sentence including the words the “machine 100 can cause,” the “server machine 100 a can cause,” or the “client machine 100 b can cause” can be carried out, at least in part, as a result of that particular machine executing software program instructions. Those software program instructions can be stored within data storage 114, 114 a, or 114 b.

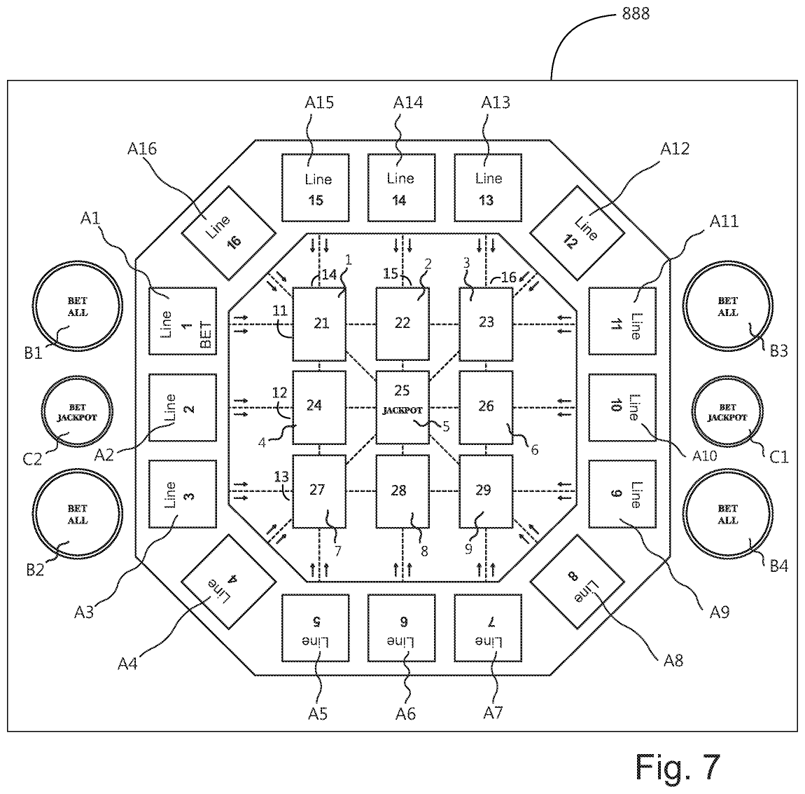

The present invention is implemented on a graphical user interface. FIG. 7 shows a board display with an octagon shape in the center of the board. An array of nine variables correspond with nine rectangular shaped image displayed as sprites or objects. The array has a first row 11, a second row 12, a third row 13, a first column 14, a second column 15, and a third column 16. The nine variables includes a first array variable 1, a second array variable 2, a third array variable 3, a fourth array variable 4, a fifth array variable 5, a sixth array variable 6, a seventh array variable 7, an eighth array variable 8, and a ninth array variable 9. Each sprite is displayed corresponding to a variable of the array. The array is displayed as a matrix of nine spaces including: space one 21, space two 22, space three 23, space four 24, space five 25, space six 26, space seven 27, space eight 28, and space nine 29.

Sixteen betting lines are displayed around and within the octagon shape and can be arranged in a counterclockwise orientation as shown in the figures, or can be arranged in a clockwise orientation. The sixteen betting lines have sixteen betting areas described above are indexed as lines one through sixteen. Each of the sixteen betting areas correspond to fields on the board display that are configured to receive user input. A user can access any of the fields by selecting it on the graphical user interface. The betting lines include line one A1, line two A2, line three A3, line four A4, line five A5, line six A6, line seven A7, line eight A8, line nine A9, line ten A10, line eleven A11, line twelve A12, line thirteen A13, line fourteen A14, line fifteen A15, and line sixteen A16. A user can, on a touch screen, for example tap a betting area for each of the lines or for all or jackpot.

Preferably, four bet all fields are displayed on the game board including a first bet all field B1, a second bet all field B2, a third bet all field B3, and a fourth bet all field B4. These bet all fields are accessible by the user for entering amounts to bet. A pair of bet all fields can be located on the right and left side of the game board. The board has a space five 25 in which a “Jackpot” symbol is related to the fifth array variable 5 displayed on space five 25. The game board contains two bet jackpot fields, namely a first bet jackpot field C1 and a second bet jackpot field C2 on a right and left side of the display as seen in FIG. 7.

The present invention is preferably operated using a single deck that populates all nine spaces, however in an alternate version, each of the nine spaces can be populated by its own deck such that there are a total of nine decks.

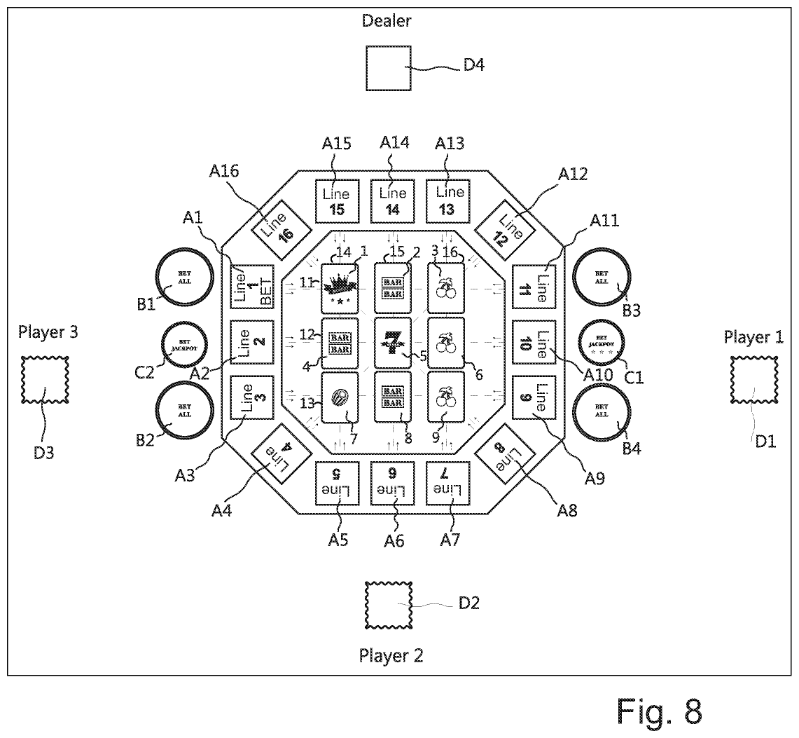

FIG. 8 depicts an arrangement of cards during game play according to an embodiment of the present invention. There are numerous manners of implementing the game having multiple hands with at least two common cards and at least some manners of implementation (and variations) are described below. The arrangement of cards depicted in FIG. 8 can be an arrangement of physical cards dealt from a deck of cards by the dealer shown in FIG. 8—D4, (the dealer). Players are shown in FIG. 8—D1, D2 and D3. In one embodiment, preferably following an initial wager a player is dealt nine (9) cards arranged in a face up position shown on the center of the octagon shape in which there are nine (9) rectangular shapes shown as FIGS. 8.1-9 and sixteen (16) betting lines shown in FIG. 8, A1-A16. The dealer displays the cards in the above-mentioned area in a fashionable order by placing the first card on the first column starting from the top to bottom and continuing to the second column from top to bottom and continuing to the third column from top to bottom. In order to have a winning bet the player must match at least two to three identical cards running consecutively, horizontally, vertically, or diagonally from all directions, including left to right, right to left, up and down, down and up, diagonally upper left to bottom right and vice versa, diagonally lower left to upper right and vice versa. The sixteen (16) betting areas described above are indexed from one (1) through sixteen (16) as shown in FIG. 8, A1-A16. Players can bet on multiple lines from lines 1 (one) through sixteen (16) and if desired the player may bet on all sixteen (16) lines at once by using any of the four (4) “Bet All” betting areas shown in FIG. 8, B1, B2, B3, and B4. Players may bet different values/amounts as desired.

Table Slot King contains a game version which provides a jackpot betting option. This version contains one jackpot card in the deck of cards. The game board contains an assigned spot for the “Jackpot” card. This designated spot for the “jackpot” card is displayed in the center of the game board located in within the center of the octagon and is specifically marked “JACKPOT” as shown in FIG. 8.5. To be evaluated as the winner of the “Jackpot” hand, the player must “Bet All” and place a fixed wager of $1.00 on the “Jackpot” symbol. The game board contains two “Bet Jackpot” symbols. One “Bet Jackpot” symbol is located on the right side of the game board as shown in FIG. 8, C1. The second “Bet Jackpot” symbol is located on the left side of the game board shown in FIG. 8, C2. The House will provide a seed amount for the “Jackpot” hand valued at $80.00. In the event that a player is evaluated and wins the “Jackpot” hand valued at $80.00, the house will seed the “Jackpot” for another $80.00 and so on. In the event that the player does not win, $1.00 goes to the “Jackpot” pool and the next “Jackpot” is set at $81.00. Each bet can be played and/or evaluated using certain aspects of blackjack, poker or other traditional card game play or evaluation.

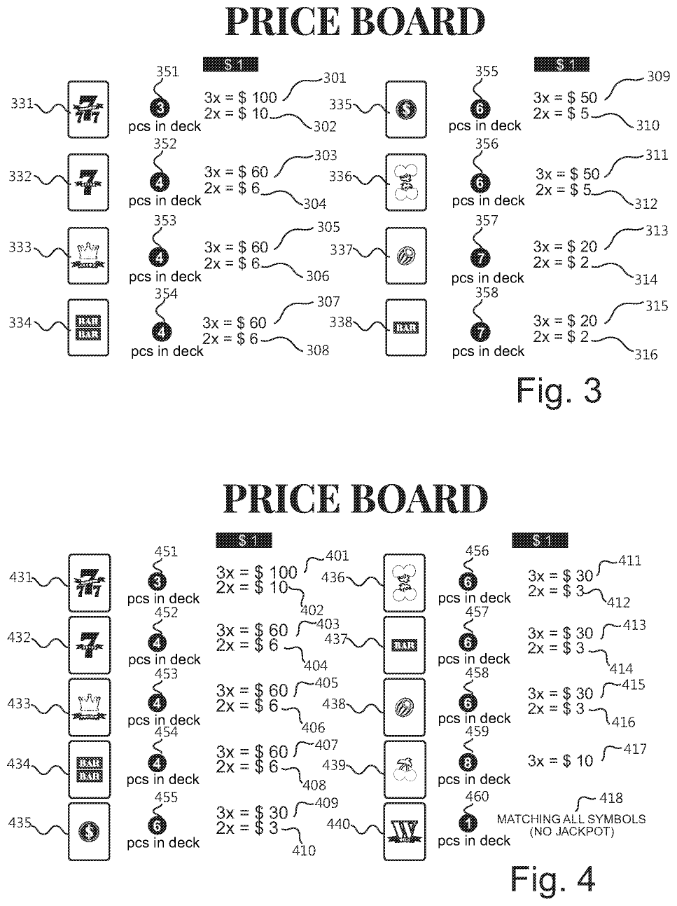

FIG. 3 displays one of the four “Price Boards” displaying the interpretation of one deck of cards for a first variation containing 41 cards showing symbols with different values as follows: seven cards containing a bar card symbol in variation one 338; four cards containing a two bar card symbol in variation one 334; seven cards containing a melon card symbol in variation one 337 four cards containing a crown card symbol in variation one 333; six cards containing a dollar sign card symbol in variation one 335; six cards containing a two cherry card symbol in variation one 336; and three cards containing a three seven card symbol in variation one 331 four cards containing a number seven card symbol in variation one 332. For every two matching cards containing a bar symbol the player receives a wining prize of $2.00, namely a winning prize of 2× bar card symbol in variation one 316. For every three matching cards containing bar symbol the player receives a wining prize of $20.00, namely a winning prize of 3× bar card symbol in variation one 315. For every two matching cards containing a bar2 symbol the players receives a wining prize of $6.00, namely a winning prize of 2× two bar card symbol in variation one 308. For every three matching cards containing a bar2 symbol the players receive a wining prize of $60.00, namely a winning prize of 3× two bar card symbol in variation one 307. For every two matching cards containing a melon symbol the player receives a wining prize of $2.00, namely a winning prize of 2× melon card symbol in variation one 314. For every three matching cards containing a melon symbol the player receives a wining prize of $20.00, namely a winning prize of 3× melon card symbol in variation one 313. For every two matching cards containing a Crown symbol the player receives a wining prize of $6.00, namely a winning prize of 2× crown card symbol in variation one 306. For every three matching cards containing a crown symbol the player receives a wining prize of $60.00, namely a winning prize of 3× crown card symbol in variation one 305. For every two matching cards containing a dollar sign symbol the player receives a wining prize of $5.00, namely a winning prize of 2× dollar sign card symbol in variation one 310. For every three matching cards containing a dollar sign symbol the player receives a wining prize of $50.00, namely a winning prize of 3× dollar sign card symbol in variation one 309. For every two matching cards contain a cherry4 symbol the player receives a wining prize of $5.00, namely winning prize of 2× four cherry card symbol in variation one 312. For every three matching cards containing a cherry4 symbol the player receives a wining prize of $50.00, namely a winning prize of 3× four cherry card symbol in variation one 311. For every two matching cards containing a seven3 symbol the player receives a wining prize of $10.00, namely a winning prize of 2× three seven card symbol in variation one 302. For every three matching cards containing a seven3 symbol the player receives a wining prize of $100.00, namely a winning prize of 3× three seven card symbol in variation one 301. For every two matching cards containing a number seven symbol the player receives a winning prize of $6.00, namely a winning prize of 2× seven card symbol in variation one 304. For every three matching cards containing a number Seven symbol the player receives a winning prize of $60.00, namely a winning prize of 3× seven card symbol in variation one 303.

FIG. 4 displays one of the four “Price Boards” displaying the interpretation of one deck of cards for a second variation containing 48 cards showing symbols with different values as follows: six cards containing a bar card symbol in variation two 437; four cards containing two bar card symbol in variation two 434; eight cards containing two cherry card symbol in variation two 439; six cards containing a melon card symbol in variation two 438; four cards containing a crown card symbol in variation two 433; four cards containing seven card symbol in variation two 432; six cards containing a dollar sign card symbol in variation two 435; six cards containing four cherry card symbol in variation two 436; three cards containing three seven card symbol in variation two 431; and one card containing a wild card symbol in variation two 440. For every two matching cards containing a bar symbol the player receives a wining prize of $3.00, namely a winning prize of 2× bar card symbol in variation two 414. For every three matching cards containing a bar symbol the player receives a wining prize of $30.00, namely a winning prize of 3× bar card symbol in variation two 413. For every two matching cards containing a bar2 symbol the player receives a wining prize of $6.00, namely a winning prize of 2× two bar card symbol in variation two 408. For every three matching cards containing a bar2 symbol the player receives a wining prize of $60.00, namely a winning prize of 3× two bar card symbol in variation two 407. For every three matching cards containing a cherry2 symbol the player receives a wining prize of $10.00, namely a winning prize of 3× two cherry card symbol in variation two 417. For every two matching cards containing a melon symbol the player receives a wining prize of $3.00, namely a winning prize of 2× melon card symbol in variation two 416. For every 3 matching cards containing a melon symbol the player receives a wining prize of $30.00, namely a winning prize of 3× melon card symbol in variation two 415. For every two matching cards containing crown symbol the player receives a wining prize of $6.00, namely a winning prize of 2× crown card symbol in variation two 406. For every three matching cards containing a crown symbol the player receives a wining prize of $60.00, namely a winning prize of 3× crown card symbol in variation two 405. For every two matching cards containing a seven symbol the player receives $6.00, namely a winning prize of 2× seven card symbol in variation two 404. For every three matching cards containing a seven symbol the player receives a wining prize of $60.00, namely a winning prize of 3× seven card symbol in variation two 403. For every two matching cards containing a dollar sign symbol the player receives a wining prize of $3.00, namely a winning prize of 3× dollar sign card symbol in variation two 410. For every three matching cards containing a dollar sign symbol the player receives a wining prize of $30.00, namely a winning prize of 3× dollar sign card symbol in variation two 409. For every two matching cards containing a cherry4 symbol the player receives a wining prize of $3.00, namely a winning prize of 2× four cherry card symbol in variation two 412. For every 3 matching cards containing a cherry4 symbol the player receives a wining prize of $30.00, namely a winning prize of 3× four cherry card symbol in variation two 411. For every two matching cards containing a seven3 symbol the player receives a wining prize of $10.00, namely a winning prize of 2× three seven card symbol in variation two 402 For every three matching cards containing a seven3 symbol the player receives a wining prize of $100.00, namely a winning prize of 3× three seven card symbol in variation two 401. For every wild card the player gets an opportunity to match the “Wild” card with any of the above symbols as desired, namely matching all symbols category in variation two 418.

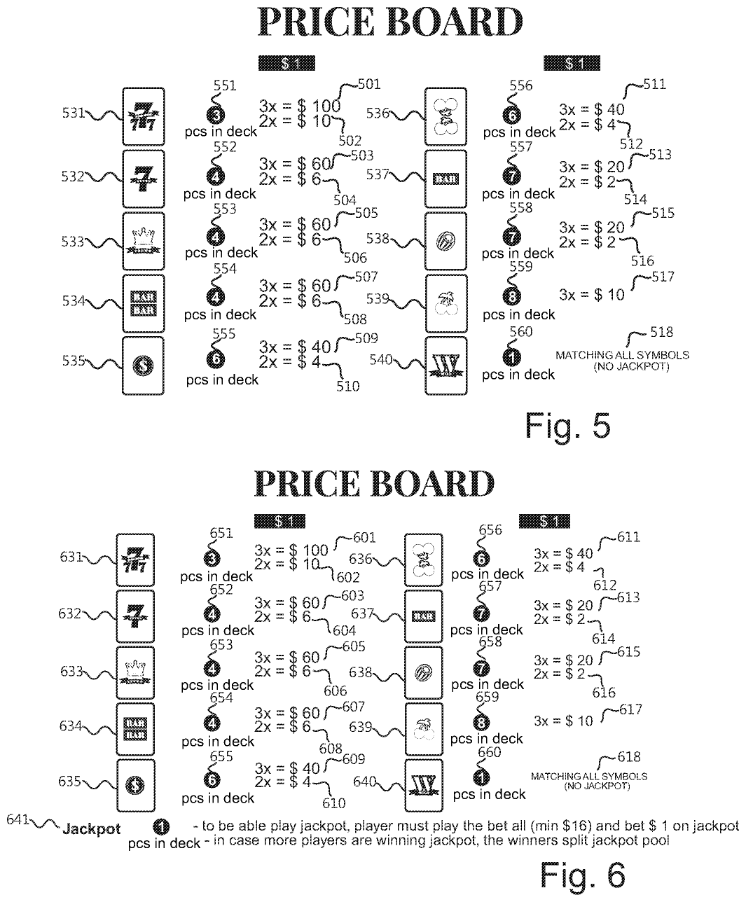

FIG. 5 displays one of the four “Price Boards” displaying the interpretation of one deck of cards for a third variation containing 50 cards showing symbols with different values as follows: seven cards containing a bar card symbol in variation three 537; four cards containing two bar card symbol in variation three 534; eight cards containing two cherry card symbol in variation three 539; seven cards containing a melon card symbol in variation three 538; four cards containing a crown card symbol in variation three 533; four cards containing a seven card symbol in variation three 532; six cards containing a dollar sign card symbol in variation three 535; six cards containing four cherry card symbol in variation three 536; three cards containing three seven card symbol in variation three 531; and one card containing a wild card symbol in variation three 540. For every two matching cards containing a bar symbol the player receives a wining prize of $2.00, namely a winning prize of 2× bar card symbol in variation two 514. For every three matching cards containing a bar symbol the player receives a wining prize of $20.00, namely a winning prize of 3× bar card symbol in variation two 513. For every two matching cards containing a bar2 symbol the player receives a wining prize of $6.00, namely a winning prize of 2× two bar card symbol in variation two 508. For every three matching cards containing a bar2 symbol the player receives a wining prize of $60.00, namely a winning prize of 3× two bar card symbol in variation two 507. For every three matching cards containing a cherry2 symbol the player receives a wining prize of $10.00, namely a winning prize of 3× two cherry card symbol in variation two 517. For every two matching cards containing a melon symbol the player receives a wining prize of $2.00, namely a winning prize of 2× melon card symbol in variation two 516. For every 3 matching cards containing a melon symbol the player receives a wining prize of $20.00, namely a winning prize of 3× melon card symbol in variation two 515. For every two matching cards containing crown symbol the player receives a wining prize of $6.00, namely a winning prize of 2× crown card symbol in variation two 506. For every three matching cards containing a crown symbol the player receives a wining prize of $60.00, namely a winning prize of 3× crown card symbol in variation two 505. For every two matching cards containing a seven symbol the player receives $6.00, namely a winning prize of 2× seven card symbol in variation two 504. For every three matching cards containing a seven symbol the player receives a wining prize of $60.00, namely a winning prize of 3× seven card symbol in variation two 503. For every two matching cards containing a dollar sign symbol the player receives a wining prize of $4.00, namely a winning prize of 3× dollar sign card symbol in variation two 510. For every three matching cards containing a dollar sign symbol the player receives a wining prize of $40.00, namely a winning prize of 3× dollar sign card symbol in variation two 509. For every two matching cards containing a cherry4 symbol the player receives a wining prize of $4.00, namely a winning prize of 2× four cherry card symbol in variation two 512. For every 3 matching cards containing a cherry4 symbol the player receives a wining prize of $40.00, namely a winning prize of 3× four cherry card symbol in variation two 511. For every two matching cards containing a seven3 symbol the player receives a wining prize of $10.00, namely a winning prize of 2× three seven card symbol in variation two 502 For every three matching cards containing a seven3 symbol the player receives a wining prize of $100.00, namely a winning prize of 3× three seven card symbol in variation two 501. For every cherry2 card the player receives a winning prize of $10.00, namely a winning prize of 3× two cherry card symbol in variation three 518. For every wild card the player gets an opportunity to match the wild card with any of the above symbols as desired, namely matching all symbols category in variation two 518.

FIG. 6 displays one of the four “Price Boards” displaying the interpretation of one deck of cards for a fourth variation containing 51 cards showing symbols with different values as follows: seven cards containing a bar card symbol in variation four 637; four cards containing two bar card symbol in variation four 634; eight cards containing two cherry card symbol in variation four 639; seven cards containing a melon card symbol in variation four 638; four cards containing a crown card symbol in variation four 633; four cards containing a seven card symbol in variation four 632; six cards containing a coin dollar sign card symbol in variation four 635; six cards containing four cherry card symbol in variation four 636; three cards containing three seven card symbol in variation four 631; one card containing a wild card symbol in variation four 640; and one card containing jackpot card symbol in variation four 641. For every two matching cards containing a bar symbol the player receives a wining prize of $2.00, namely a winning prize of 2× bar card symbol in variation two 614. For every three matching cards containing a bar symbol the player receives a wining prize of $20.00, namely a winning prize of 3× bar card symbol in variation two 613. For every two matching cards containing a bar2 symbol the player receives a wining prize of $6.00, namely a winning prize of 2× two bar card symbol in variation two 608. For every three matching cards containing a bar2 symbol the player receives a wining prize of $60.00, namely a winning prize of 3× two bar card symbol in variation two 607. For every three matching cards containing a cherry2 symbol the player receives a wining prize of $10.00, namely a winning prize of 3× two cherry card symbol in variation two 617. For every two matching cards containing a melon symbol the player receives a wining prize of $2.00, namely a winning prize of 2× melon card symbol in variation two 616. For every 3 matching cards containing a melon symbol the player receives a wining prize of $20.00, namely a winning prize of 3× melon card symbol in variation two 615. For every two matching cards containing crown symbol the player receives a wining prize of $6.00, namely a winning prize of 2× crown card symbol in variation two 606. For every three matching cards containing a crown symbol the player receives a wining prize of $60.00, namely a winning prize of 3× crown card symbol in variation two 605. For every two matching cards containing a seven symbol the player receives $6.00, namely a winning prize of 2× seven card symbol in variation two 604. For every three matching cards containing a seven symbol the player receives a wining prize of $60.00, namely a winning prize of 3× seven card symbol in variation two 603. For every two matching cards containing a dollar sign symbol the player receives a wining prize of $4.00, namely a winning prize of 3× dollar sign card symbol in variation two 610. For every three matching cards containing a dollar sign symbol the player receives a wining prize of $40.00, namely a winning prize of 3× dollar sign card symbol in variation two 609. For every two matching cards containing a cherry4 symbol the player receives a wining prize of $4.00, namely a winning prize of 2× four cherry card symbol in variation two 512. For every 3 matching cards containing a cherry4 symbol the player receives a wining prize of $40.00, namely a winning prize of 3× four cherry card symbol in variation two 611. For every two matching cards containing a seven3 symbol the player receives a wining prize of $10.00, namely a winning prize of 2× three seven card symbol in variation two 602 For every three matching cards containing a seven3 symbol the player receives a wining prize of $100.00, namely a winning prize of 3× three seven card symbol in variation two 601. For every cherry2 card the player receives a winning prize of $10.00, namely a winning prize of 3× two cherry card symbol in variation three 617. For every wild card the player gets an opportunity to match the wild card with any of the above symbols as desired, namely matching all symbols category in variation two 618. Note: There is only one “Wild” card in this card variation. In this variation there is only one “Jackpot” card. For the players who receive this card in order to be able to play the jackpot the player must play the bet all (minimum $16.00) and additionally bet $1.00 on jackpot and in case more than one player wins the jackpot, the winners must split the jackpot pool, namely a jackpot card symbol in variation four 641.

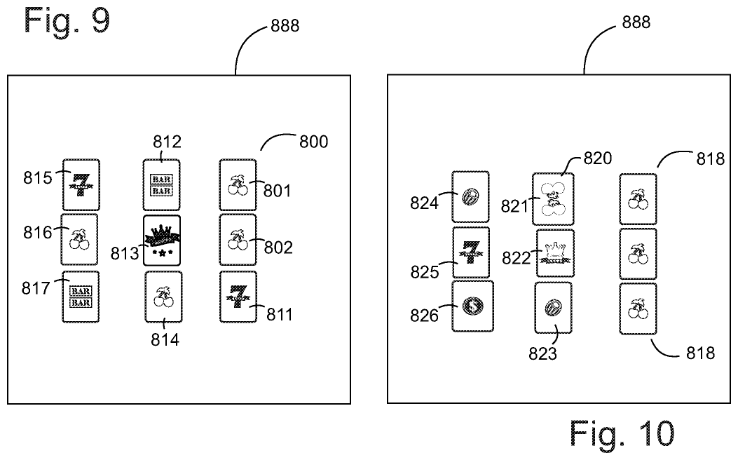

As seen in FIG. 9, the graphical display screen 888 displays the cards in an array conforming to a grid. The game can include one or more hold cards 800, such as a first hold card 801, and a second hold card 802. The user can pick the cards that are almost making a match such as in a 3×3 array where there are a pair of cards in a row and the user is attempting to complete a three in a row match. Keeping two out of nine cards defines the two hold cards 800 and leads to a first replacement card 811, a second replacement card 812, a third replacement card 813, a fourth replacement card 814, a fifth replacement card 815, a sixth replacement card 816, and a seventeenth replacement card 817. The array of cards is thus populated twice. The array of cards is populated a first time, and then the user selects cards to hold by pressing the graphical user display 888 that is preferably implemented as a touch screen. The array of cards is that populated a second time except for the hold cards.

As seen in FIG. 10, the graphical display screen 888 continues to display the cards in an array conforming to a grid after the user has selected the hold cards and the replacement cards. The user in this case was lucky and has winning cards 818 which are three in a row. New cards 820 include a first new card 821, a second new card 822, a third new card 823, a fourth new card 824, a fifth new card 825, a sixth new card 826, and a seventh new card 827. In this situation, the user wins a three in a row cherry combination on the right hand column.

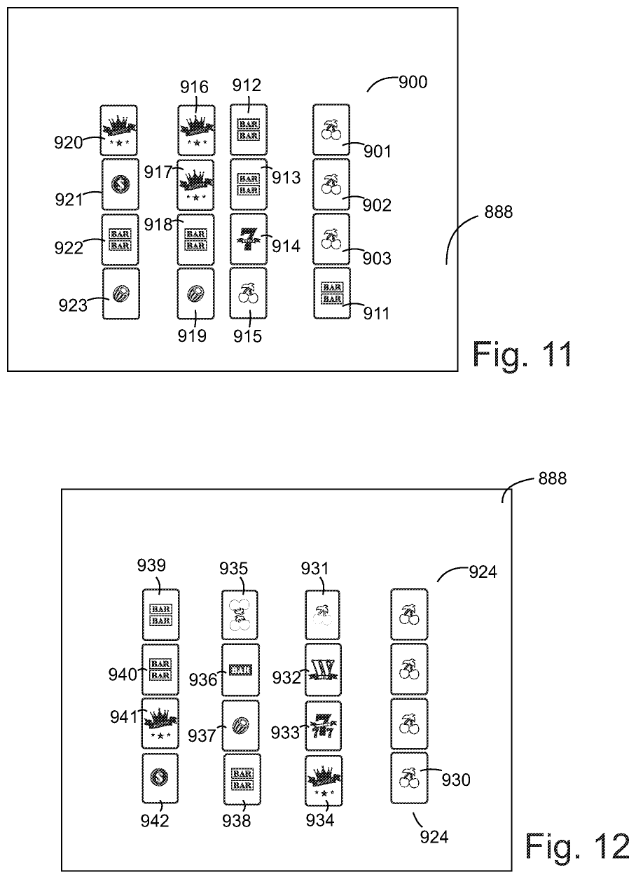

As seen in FIG. 11, the graphical display screen 888 continues to display the cards in an array conforming to a grid. In a four by four configuration, the hold cards 900 may include a first hold card 901, a second hold card 902, and a third hold card 903. The user can retain these cards while the other cards are discarded. The replaced cards may include a first replaced card 911, a second replaced card 912, a third replaced card 913, a fourth replaced card 914, a fifth replaced card 915, a sixth replaced card 916, a seventh replaced card 917, an eighth replaced card 918, a ninth replaced card 919, a tenth replaced card 920, an eleventh replaced card 921, a twelfth replaced card 922, and a thirteenth replaced card 923.

As seen in FIG. 12, four in a row winning cards 924 can result from discarding and replacing the first replaced card 911. In this situation, the user wins a four in a row cherry combination on the right hand column.

1. A method of conducting a game of chance comprising the steps of:
a. providing a processor for an electronic gaming device, wherein said processor is configured to graphically output a game table on a display, wherein the display is a graphical user display;
b. defining at least a square array of three rows by three columns;
c. defining a deck of cards, and assigning each card in the deck of cards a card symbol, wherein some of the cards symbols are duplicates or triplicates of each other, wherein the number of cards is a preset finite amount;
d. defining betting lines along the rows, columns and diagonals of the square array, receiving bet inputs from players on the betting lines;
e. configuring the processor to populate the array with cards by selecting a set of cards from the deck of cards and assigning the selected set of cards to the spaces in the square array, then configuring the processor to cause a graphical display to display the card symbols related to each card in the selected set of cards;
f. determining a payout according to a price board payout chart by comparing all of the selected cards on all of the betting lines and then multiplying the bet by the payout;
g. configuring the processor to allow the user to select one or more hold cards of the set of cards shown on the graphic user display; and configuring the processor to repopulate discarded cards, which are the cards that are not the hold cards.

2. The method of conducting a game of chance of claim 1, wherein the card symbols are populated on the square array one at a time with a delay between cards, wherein the card symbols are populated one row at a time, wherein the display is a touch screen.

3. The method of conducting a game of chance of claim 1, wherein the price board payout chart is configured to provide a winning bet when at least two of three selected card symbols are consecutive on a betting line in a horizontal, vertical, or diagonal orientation from all directions, including left to right, right to left, up to down, down to up, diagonally upper left to bottom right and vice versa, and diagonally lower left to upper right and vice versa.

4. The method of conducting a game of chance of claim 1, wherein sixteen betting lines are defined around the 3×3 array, wherein each betting line has a betting area for receiving a user input, which is indexed from one through sixteen.

5. The method of conducting a game of chance of claim 4, the processor is configured to receive bets from players on multiple lines from line one through line sixteen and if desired the player may bet on all sixteen lines at once by using a bet all betting area located on the game board.

6. The method of conducting a game of chance of claim 1, further comprising the step of configuring the processor to provide a bet jackpot area, and further including a jackpot card in the deck of cards; defining a space in the square array as a jackpot space assigned spot for the jackpot card, wherein the payout table includes a condition of having a jackpot card in the jackpot space, wherein the jackpot is won when the jackpot card appears in the jackpot space.

7. The method of conducting a game of chance of claim 6, wherein the jackpot space is defined in the center of the game board, which is space five on a square array of three rows by three columns, wherein the jackpot space is marked as a jackpot space.

8. The method of conducting a game of chance of claim 1, wherein the processor is configured to allow a jackpot bet on the bet jackpot area only when a player puts a bet in the bet all area and places a fixed wager on the “Jackpot” symbol located on the game board.

9. The method of conducting a game of chance of claim 8, wherein the game board has two bet jackpot bet areas, mainly a first bet jackpot area is located on a right side of the game board and second that a bet jackpot area located on a left side of the game board.

10. The method of conducting a game of chance of claim 8, wherein an initial value of the jackpot is seeded at a set amount.

11. The method of conducting a game of chance of claim 8, wherein the jackpot is progressive and increases with all losing bets.
